(19) United States
(12) Patent Application Publication
(10) Pub. No.: US 2008/0268950 A1
(43) Pub. Date: Oct. 30, 2008

(54) VIDEO CONSOLE DISPLAY SCREEN/HOUSING AND INTEGRATED SENSING BAR

(76) Inventors: Saied Hussaini, Miami, FL (US); Marc Iacovelli, Miami, FL (US)

Correspondence Address: BERENATO, WHITE & STAVISH, LLC, 6550 ROCK SPRING DRIVE, SUITE 240, BETHESDA, MD, 20817, US

(21) Appl. No.: 12/053,844

(22) Filed: Mar. 24, 2008

Related U.S. Application Data
(60) Provisional application No. 60/907,984, filed on Apr. 25, 2007.

(51) Int. Cl. A63F 9/24; A63F 13/00

(52) U.S. Cl. 463/31

(57) ABSTRACT

The present invention is directed to a portable video display unit adapted for removably housing and positively retaining an electronic video game console. A casing includes a substantially flat top surface and an access opening for receiving the electronic video game console. The video display panel includes a viewing surface provided with a display screen pivotally mounted to the casing for pivoting between a stowed position and an exposed deployed position. In the deployed position the video display member projects outwardly from the top surface with the display screen oriented so as to be viewable by a user. The casing includes an audio/video connector and a power connector and is adapted to engage complementary audio/video and power connectors of the electronic video game console. The video display panel further includes an integral sensing bar formed into the viewing surface of the display unit.

This application claims the benefit of U.S. provisional application 60/907,984 filed on Apr. 25, 2007 and is hereby incorporated herein by reference in its entirety.

### BACKGROUND OF THE INVENTION

1. Field of the Invention

The present invention relates to consumer electronics, and more particularly to a detachable compact screen game screen apparatus and housing for a video game console having a unique swivel screen panel and integrated sensing bar.

2. Description of the Related Art

Various electronic video-processing devices, such as video game consoles, video players (DVD players or VCRs), etc., are becoming more and more popular. Usually, they include a box-shaped casing provided with as plurality of female plugs for interconnecting to two or more respective control units, a TV monitor and a power adapter. Typically, the electronic video-processing devices are sold separately, without a dedicated display screen, and are adapted to work with conventional TV monitors. Therefore, when children without a TV in their rooms are playing video games or using the video player, they are tying family TV monitors, precluding other household members from watching regular TV shows. Game screens for gaming consoles are known in the art which are simple video screens which are disposed on top of a gaming console and roughly secured in a crude manner and connect to audio/video outputs in a conventional manner much like a televisions. Such systems, or simple video devices, simply act like small televisions with a flip up screen. These screens simply flip up n one direction to expose the screen and fold back down to reset against the console.

Personal lap top computers incorporate picot and swivel screens such as described in U.S. Pat. Nos. 7,130,186, 7,133,280, 7,123,472, 6,867,961, 6,742,221 each of which are hereby incorporated herein by reference. However, these computers systems are permanently secured to the computers housing and do not provide the ability to selectively and detachably connect to a gaming console. These lap top devices also do not provide the ability to house or cradle such gaming consoles providing not only protection for the console device, but the ability to ergonomically dispose the entire gamine console and screen as a single compact unit.

### SUMMARY OF THE INVENTION

The present invention is directed to a portable video display unit including a cage-type casing adapted for removably housing and positively retaining an electronic video game console. The cage-type casing defines an enclosed cavity there within substantially complementary to the electronic video game console. The casing includes a substantially flat top surface and an access opening for receiving the electronic video game console. The video display panel includes a viewing surface provided with a display screen pivotally mounted to the casing for pivoting between a stowed position wherein the video display panel is substantially parallel to the top surface so that the viewing surface faces the top surface, to an exposed position wherein the video display panel is substantially parallel to the top surface so that the back surface faces the top surface. In a deployed position the video display member projects outwardly from the top surface with the display screen oriented so as to be viewable by a user. The cage-type casing includes an audio/video connector and a power connector and is adapted to engage complementary audio/video and power connectors of the electronic video game console. The video display panel further includes an integral sensing bar formed into said viewing surface thereof. The integral sensing bar emits a plurality of signals marking a position of the d viewing surface of said video display panel relative to a remote controller of the electronic video game console.

### BRIEF DESCRIPTION OF THE DRAWINGS

FIG. 1 depicts a front elevation perspective view of the console display according to a preferred embodiment.

FIG. 2 depicts a front view of the display unit of FIG. 1.

FIG. 3 depicts a rear view of the display unit of FIG. 1.

FIG. 4 depicts a right side view of the display unit of FIG. 1.

FIG. 5 depicts a left side view of the display unit of FIG. 1.

FIG. 6 depicts a top view of the display unit of FIG. 1.

FIG. 7 depicts a bottom view of the display unit of FIG. 1.

FIG. 8 depicts a front elevation perspective view of the display of FIG. 1 with the display panel in the closed position.

FIG. 9 depicts a front elevation perspective view of the console display of FIG. 1 in combination with and gaming console.

FIGS. 10-14 are various circuit schematics associated with video display and integrated sensing bar of the present invention.

### DESCRIPTION OF A PREFERRED EMBODIMENT

The preferred embodiment will now be described. The present invention is particularly suited for connection and interaction with Nintendo's WII gaming console and the dimensions of the Wii console, as it exists concurrently with the filing of this instant application.

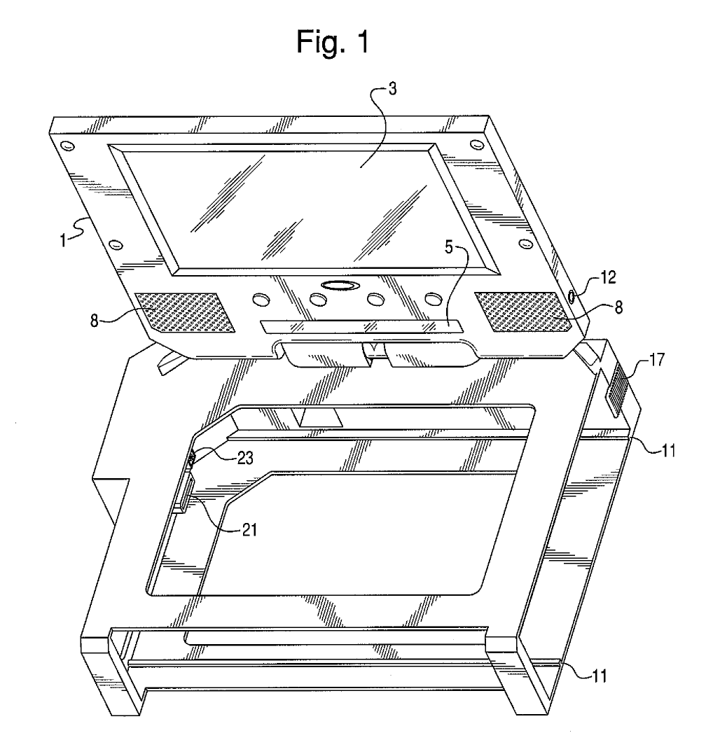

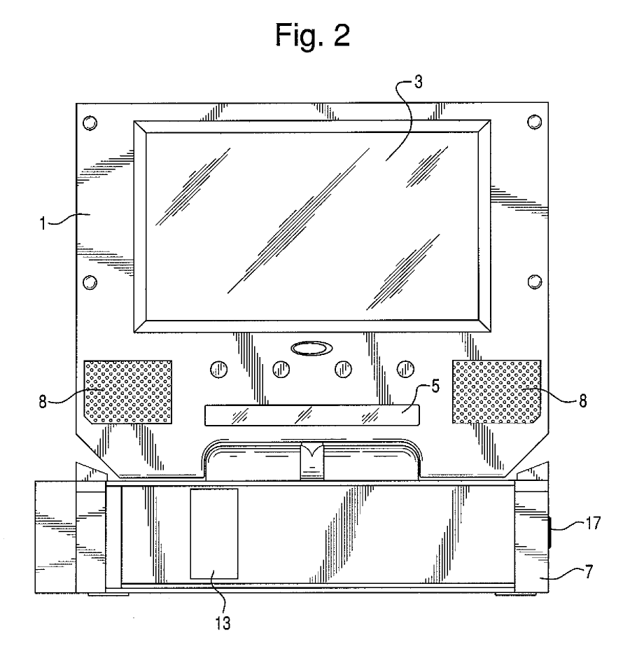

Reference will now be made to the attached drawing sheets. FIG. 1 depicts the gaming screen having a screen panel 1, with integrated LCD screen 3, a standard variety of control buttons (on/off volume, LCD menu), speakers 8, headphone jack 12, and an integrated sensing bar 5 disposed just below the LCD screen and centered therewith. The entire screen panel 1 is pivotally connected to a cage type casing 7. The screen panel may both pivot upwards in excess of 1880 degrees as conventional flip up panel and additional may swivel 180 degrees such that is can sit back flush against the casing 7 with the screen 3 exposed. Any numbers of pivot/swivel joints may be connection such as disclosed in U.S. Pat. Nos. 7,130,186 7,133,280, 7,123,472, 6,867,961, and 6,742,221 that need not be elaborated further. The casing also incorporates alignment features 11 to ensure that a gaming console disposed therein is properly fitted and contained. The screen housing also incorporates integrated connections to facilitate communication with the gaming console such as audio/video outputs as well as the input for the sensing bar.

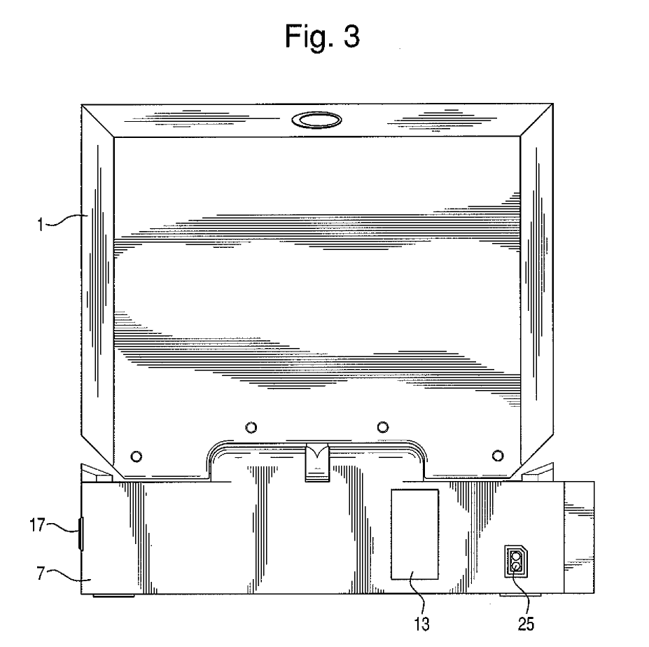

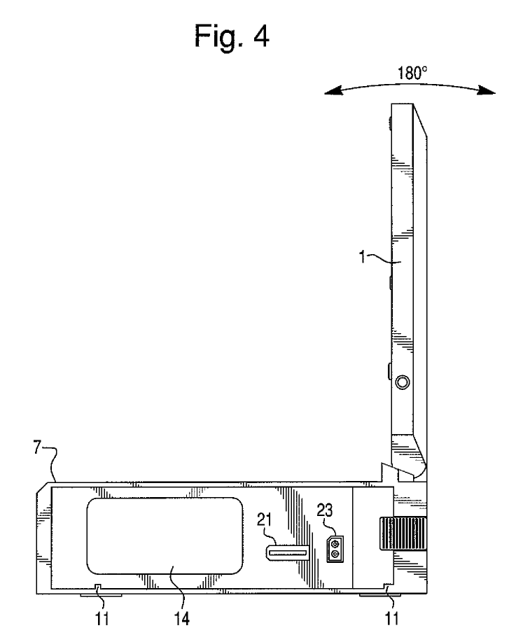

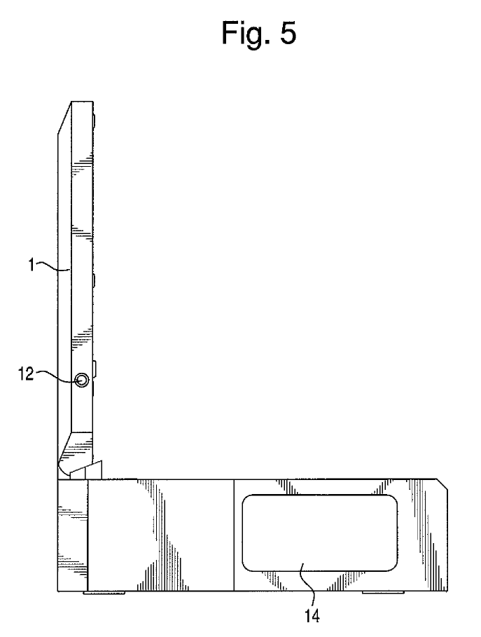

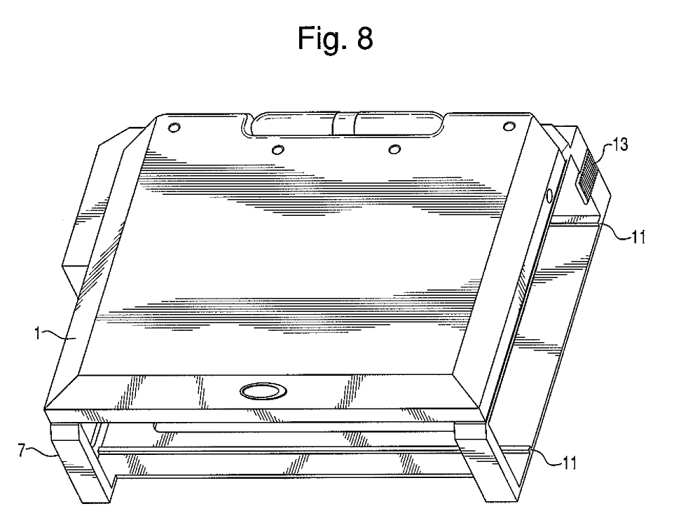

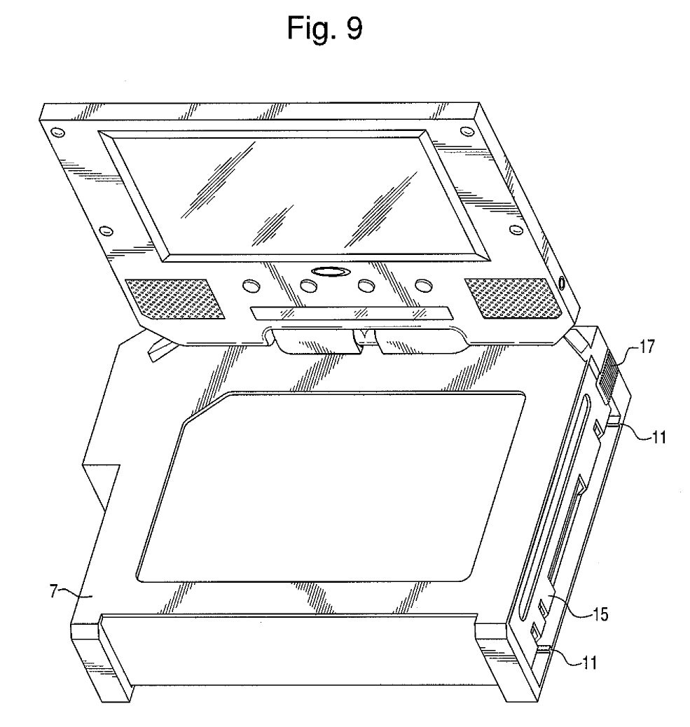

FIGS. 3-4 depicts a rear and side views of the integrated game screen housing with a rear 13 and side 14 ventilation/access opening 13,14. The side opening 14 allows for external devices to be connected to the gaming consoles USB) ports. As previously indicated the integrated game screen with the LCD panel can be rotated and pivoted such that the screen rests flush against the housing with the LCD screen exposed, 180 degrees from the closed position shown in FIG. 8. FIG. 9 depicts the integrated game screen and housing with a WII console disposed therein in. As can be seen two guide rails 11, engaged recessed grooves formed in the bottom of the gaming console. The two rails (one extended rail and one ledge) provide for precise retentions within the casing and proper alignment with connections in the side of the housing. Once the console 15 is disposed within the housing, a retention tab 17 is simply slid inward to prevent the console from emerging from the housing. As can be seen in FIG. 9, and the remaining figures, the casing 7 comprises numerous openings to expose the surface of the gaming console and also to allow proper ventilation from the gaming systems exhaust. However all corners and peripheral edges of the gaming console are protected by the casing and the console is securely retained within the casing 7.

When the gaming console is disposed within the casing 7 with the display panel rotated and swiveled such that the LCD panel lies flush against the casing, the entire unit, game screen and console, form a compact structure which may be oriented and otherwise supported or positioned for viewing by a user without the need for the display to be raised or otherwise be in an extended vulnerable position. The video game can be played and viewed without the display panel rotated in an upward position. The compact arrangement facilitates portability and reduces the possibility of damaging the display panel. The compact arrangement also allows to be simply secured to the back of an automobile seat when coupled with a simple boxlike harness.

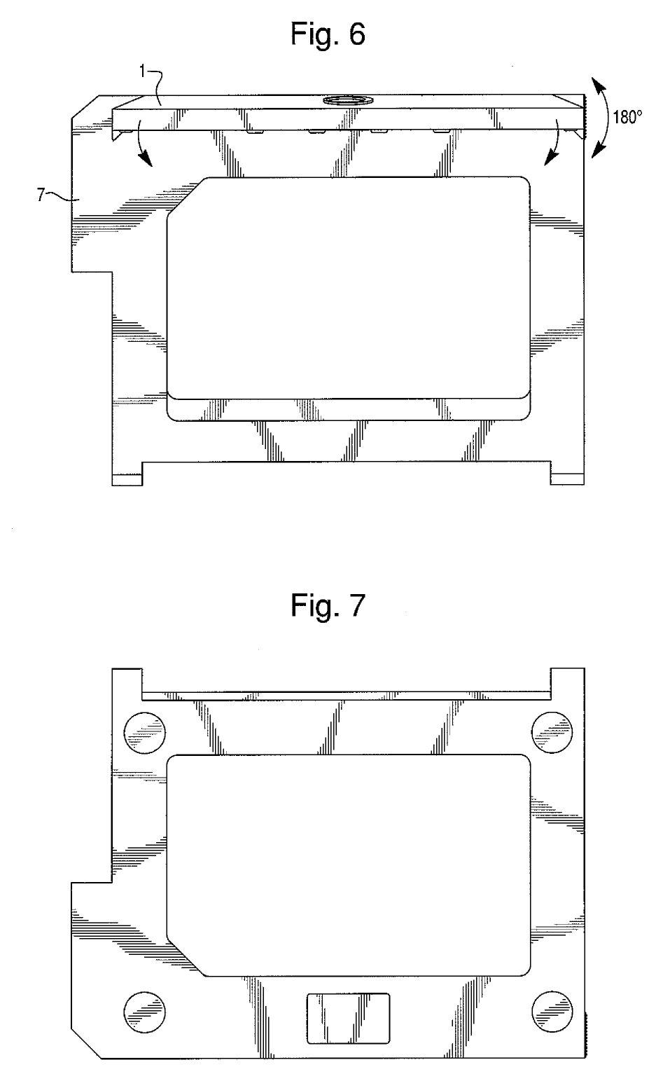

FIG. 6 depicts a top view of the integrated display showing the directional movement of the display panel 1 relative to the casing 7 when in the upright position. As can be seen in FIG. 4 the panel 1 may both pivot upward from the flush position to a raised position through ninety degrees and is capable of pivoting through 180 degrees to lie parallel to the casing top surface. Thus the display panel is capable of compound rotational movement first by pivoting about a first axis parallel to the top surface of the casing, and may also pivot 180 degrees along a second axis perpendicular to the first axis. The compound pivoting and swivel movement allows for the screen to be flipped exposing the LCD screen while lying flush against the casing and gaming console. As can be seen in FIG. 3-4, the housing 7 includes openings for venting and connection to the gaming console. FIG. 4 A depicts a right side view of the integrated screen. As can be seen an audio video plug and controller port plug 21 are formed in the inside surface of the left side of the casing. A power plug 23 is also provided to engage the power input port of the gaming console. This audio-video plug also for direct connection to the gaming console to provide A/V signals to the game screen without the necessity for additional audio video cables etc. The power plug 23 constitutes a pass through to DC power input port 25 shown in the rear portion of the casing as shown in FIG. 3. This allows external connection of a power cord to the casing as part from a direct connection to the console. The game screen is provided by an external twelve-volt power supply, which may either be provided by a proper connection to a 12-volt source such as a cigarette lighter of an automobile or via an inverter in turn connected to a 120 volt AC source. The power input powers both the display and the gaming console through power input plug 23. The plug connections 21,23 also provide additional structural support and a more firm connection between the housing and the console and otherwise eliminate the necessity for direct connection of external cables to the gaming console itself.

As previously discussed the game screen incorporates an integrated sensing bar. Sensing bars of the related art are lengthy separate external devices having 20 cm in length or greater. As many as ten LEDs five each disposed at either end of the bars. The bars of the related art are separate external devices which must be carefully disposed adjacent the television or game screen with no positive connection to the video display or other mechanism to precisely and permanently position the bar. Such sensing bars which are not fixed or otherwise accurately disposed, allow for improper alignment and thus inaccurate interaction with the WII remote. The remote controller must accurately sense the direction from which the LED illuminates infrared waves in order to provide accurate and heightened game play. Moreover, the prior art sensing bars are at least 20 centimeters in length that is much too large and cumbersome to work with a portable game screen such as the screen/housing of the present invention.

Thus the present game screen panel incorporates a small integrated sensing bar with a series of logistically disposed LEDS to provide infrared illumination from fixed points relative to the game screen. The Wii remote controllers thus interact with the sensing bar on a consistent basis. This not only provide the ability to provide more accurate and heightened play, but since the bar is permanently integrated with the display screen, a player will easily learn interaction with Wii remote which will remain consistent and thus the player will gain experienced with a higher level of play simply due to the predictable nature of the interaction with the remotes. The prior art sensing bars have inherent variants due to the inconsistent disposition relative to the game screen which plagues the prior art sensing bars as they are not permanently integrated with the display screen and thus their relative position to the display screen will vary. Moreover, the sensing bars of the prior art are vulnerable to movement after they are installed. This results in inconsistent game play. The integrated sensing bar of the present invention also eliminates any external connections both in terms of power and communication.

The LEDS of the sensing bar of the present invention are logistically arranged and positioned such that the LED farthest away from the center is pointed slightly away from the center; the LED closest to the center is pointed slightly toward the center, while the three LEDs between them are pointed straight forward and grouped together. The bar is centered just below the LCD screen in line with the front of the surface the television is placed on and provides consistent pointing towards any remote controller used to locate the Sensor Bar's points of light in the.

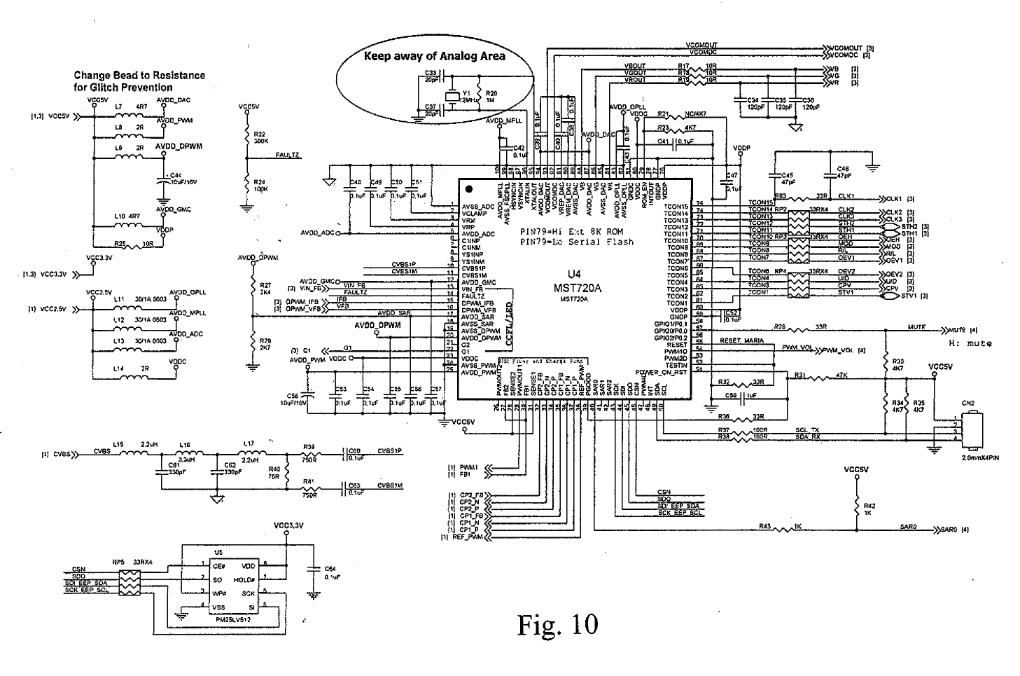

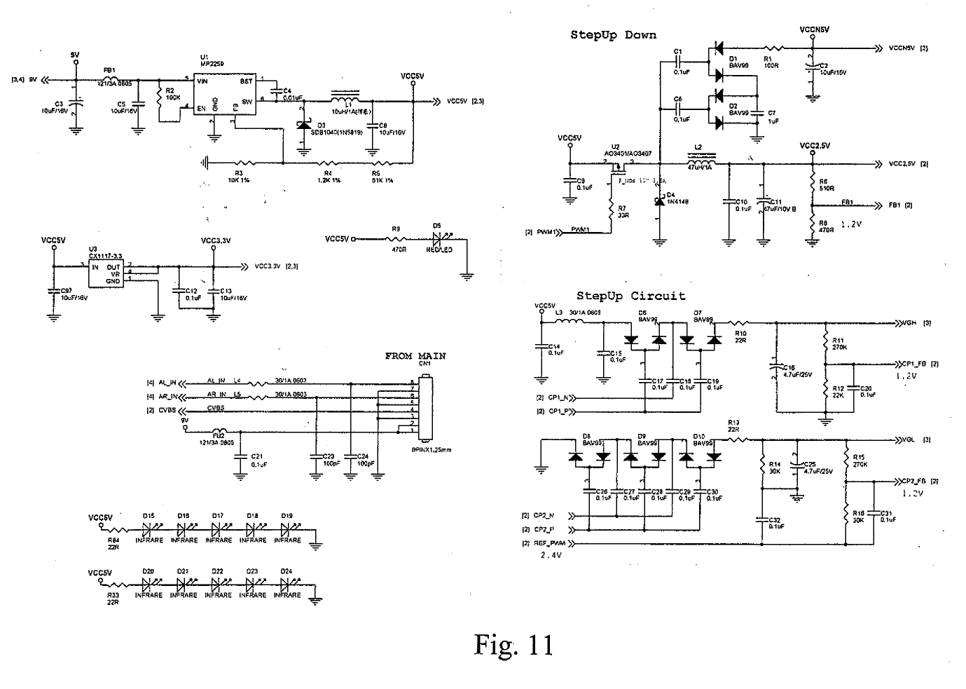

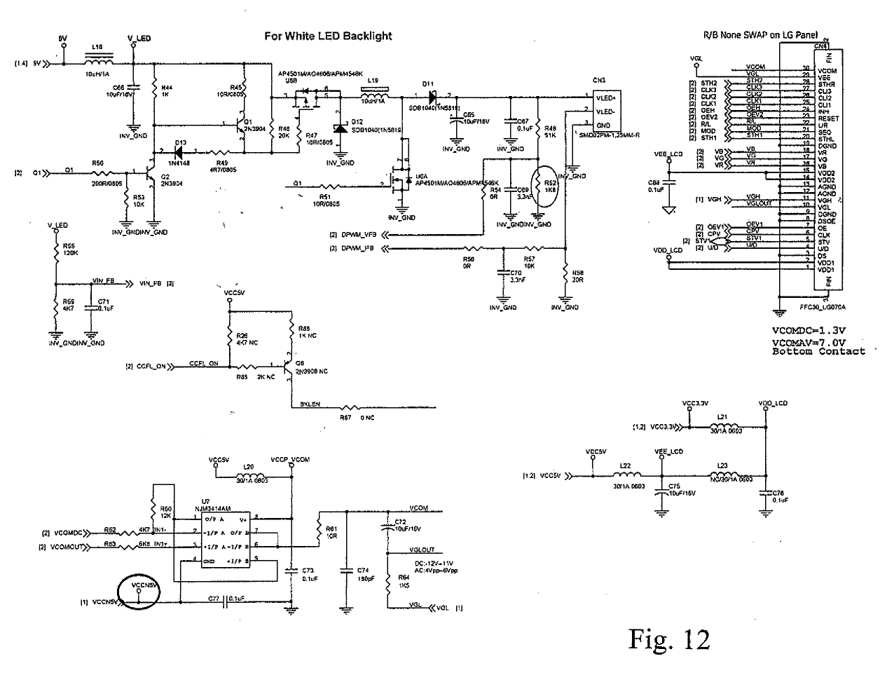

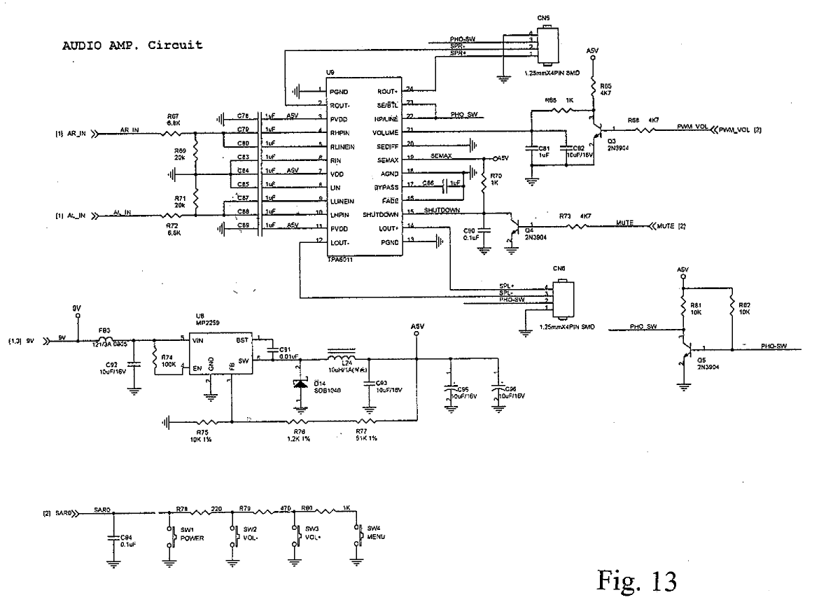

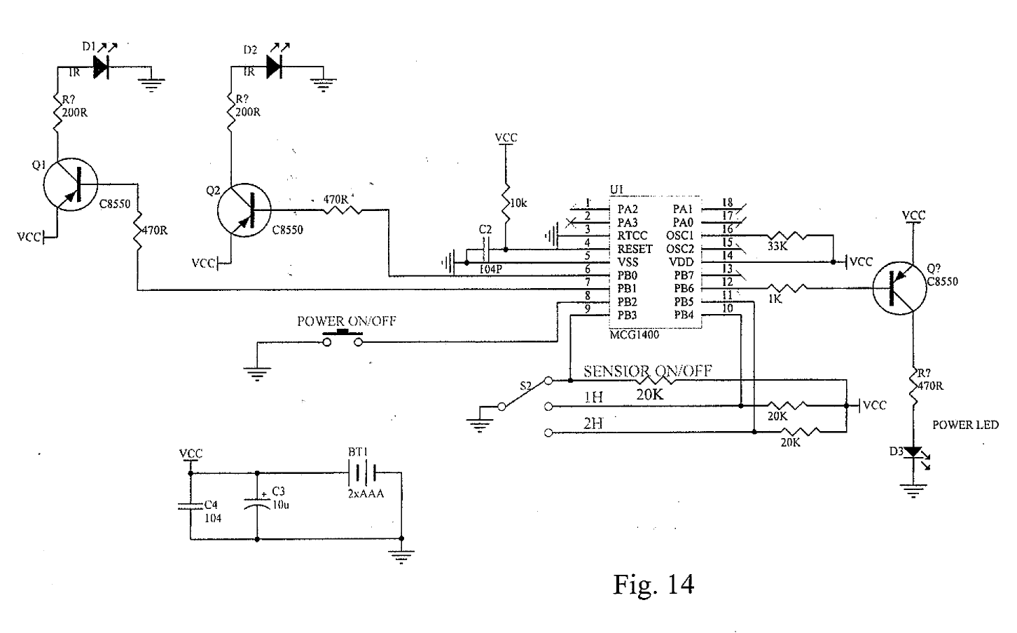

FIGS. 10-14 are circuit schematics of the video display and integrated sensing bar of the preferred embodiment. One of ordinary skill in the art will recognize the circuits sufficient to make and use the present invention. FIG. 10 depicts the electrical schematic of the entire circuit. FIG. 13 is an isolated schematic of the audio amplifier circuit. FIG. 14 is an isolated schematic of the sending bar circuit.

While the foregoing invention has been shown and described with reference to a preferred embodiment, it will be understood by those possessing skill in the art that various changes and modifications may be made without departing from the spirit and scope of the invention.

What is claimed is:

1. A portable video display unit comprising:
a cage-type casing adapted for removably housing and positively retaining an electronic video game console therein, said cage-type casing defining an enclosed cavity there within substantially complementary to said electronic video game console, said casing having a substantially flat top surface and an access opening for receiving said electronic video game console in said cavity; and
a video display panel including a viewing surface provided with a display screen and a back surface opposite to said viewing surface, said video display panel being pivotally mounted to said casing for pivoting between a stowed position wherein said video display panel is substantially parallel to said top surface so that said viewing surface faces said top surface, an exposed position wherein said video display panel is substantially parallel to said top surface so that said back surface faces said top surface, and a deployed position wherein said video display member projects outwardly from said top surface with said display screen oriented so as to be viewable by a user of said electronic video game console;
said cage-type casing including an audio/video connector and a power connector provided inside said cage-type casing and adapted to engage complementary audio/video and power connectors of said electronic video game console;
said video display panel further including an integral sensing bar formed into said viewing surface thereof said integral sensing bar emitting a plurality of signals marking a position of said viewing surface of said video display panel relative to a remote controller of said electronic video game console.

2. The portable video display unit as defined in claim 1, wherein said cage-type casing has at least one guide rail adapted to engage at least one recessed groove formed in a bottom surface of said electronic video game console for orienting and positively retaining said electronic video game console in said cage-type casing.

3. The portable video display unit as defined in claim 1, wherein said cage-type casing includes a locking mechanism provided to releasably positively secure said electronic video game console in said cage-type casing.

4. The portable video display unit as defined in claim 1, wherein said locking mechanism includes a locking tab that engages an outer peripheral surface of said electronic video game console to prevent said electronic video game console from moving relative to said cage-type casing.

5. The portable video display unit as defined in claim 1, wherein said cage-type casing comprises numerous openings provided to expose an outer surface of said electronic video game console and to allow proper ventilation from said electronic video game console.

6. The portable video display unit as defined in claim 1, further including a hinge assembly pivotally connecting said video display panel to said cage-type casing, said hinge assembly being rotatable about two axes of rotation to permit said video display panel to swivel about a first axis of rotation and to swivel about a second axis of rotation relative to said cage-type casing.

7. The portable video display unit as defined in claim 1, wherein said plurality of signals emitted by said sensing bar is a plurality of infrared waves.

8. The portable video display unit as defined in claim 6, wherein said sensing bar includes a logistically disposed series of LEDs provided to emit said infrared waves from fixed points relative to said viewing surface of said video display panel.

9. The portable video display unit as defined in claim 1, wherein said viewing surface of said video display panel is provided with a plurality of control buttons for operating said video player device.

10. The portable video display unit as defined in claim 1, wherein said video display panel includes a pair of built-in stereo speakers located on both sides of said viewing surface thereof for providing a stereo sound.
